(19) United States
(12) Patent Application Publication
(10) Pub. No.: US 2026/0010867 A1
(43) Pub. Date: Jan. 8, 2026

(54) Adaptive Inventory Tracking Systems and Methods

(71) Applicant: ZEBRA TECHNOLOGIES CORPORATION, Lincolnshire, IL (US)

(72) Inventors: Harika Jayanthi, Bangalore (IN); Timothy B. Austin, Stony Brook, NY (US)

(21) Appl. No.: 18/829,118

(22) Filed: Sep. 9, 2024

Related U.S. Application Data
(60) Provisional application No. 63/667,105, filed on Jul. 2, 2024.

(51) Int. Cl. G06Q 10/087; G06K 7/10

(52) U.S. Cl. CPC G06Q 10/087; G06K 7/10366

(57) ABSTRACT

A method includes: storing a plurality of identifiers of radiofrequency (RF) tags, and for each identifier, an indicator of whether the corresponding RF tag is present in a facility; receiving read data containing a subset of the identifiers detected by a RF identification (RFID) reader; for each of the plurality of identifiers: (i) generating a feature vector by combining the read data with contextual data corresponding to the identifier; and (ii) executing a reinforcement learning module using the feature vector to select an action predictive of whether the corresponding RF tag is present in the facility; updating the stored indicators according to the selected actions; and for each identifier in the subset detected by the RFID reader, applying a reward to the reinforcement learning module based on a comparison of the indicator and the updated indicator corresponding to the identifier.

### CROSS-REFERENCE TO RELATED APPLICATIONS

This application claims priority from U.S. Provisional Patent Application No. 63/667105, filed July 2, 2024, the contents of which is incorporated herein by reference.

### BACKGROUND

Radiofrequency (RF) tags affixed to items of merchandise can be employed to track the items of merchandise or the like in a facility, e.g., via RF identification (RFID) readers deployed in the facility. Environmental factors such as physical obstructions, and characteristics of the items, however, may cause RFID readers to fail to detect some tags.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a system for inventory tracking.

FIG. 2 is a diagram illustrating certain internal components of the computing device of the system of FIG. 1.

FIG. 3 is a flowchart of a method of adaptive inventory tracking.

FIG. 4A is a diagram of RF tag identifiers and presence indicators stored at block 305 of the method of FIG. 3.

FIG. 4B is a diagram of read results received at block 310 of the method of FIG. 3.

FIG. 5 is a diagram illustrating an example performance of block 315 of the method of FIG. 3.

FIG. 6 is a diagram illustrating an example performance of blocks 320 to 335 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: storing a plurality of identifiers of radiofrequency (RF) tags, and for each identifier, an indicator of whether the corresponding RF tag is present in a facility; receiving read data containing a subset of the identifiers detected by a RF identification (RFID) reader; for each of the plurality of identifiers: (i) generating a feature vector by combining the read data with contextual data corresponding to the identifier; and (ii) executing a reinforcement learning module using the feature vector to select an action predictive of whether the corresponding RF tag is present in the facility; updating the stored indicators according to the selected actions; and for each identifier in the subset detected by the RFID reader, applying a reward to the reinforcement learning module based on a comparison of the indicator and the updated indicator corresponding to the identifier.

Additional examples disclosed herein are directed to a computing device, comprising: a memory storing a plurality of identifiers of radiofrequency (RF) tags, and for each identifier, an indicator of whether the corresponding RF tag is present in a facility; and a processor configured to: receive read data containing a subset of the identifiers detected by a RF identification (RFID) reader; for each of the plurality of identifiers: (i) generate a feature vector by combining the read data with contextual data corresponding to the identifier; and (ii) execute a reinforcement learning module using the feature vector to select an action predictive of whether the corresponding RF tag is present in the facility; update the stored indicators according to the selected actions; and for each identifier in the subset detected by the RFID reader, apply a reward to the reinforcement learning module based on a comparison of the indicator and the updated indicator corresponding to the identifier.

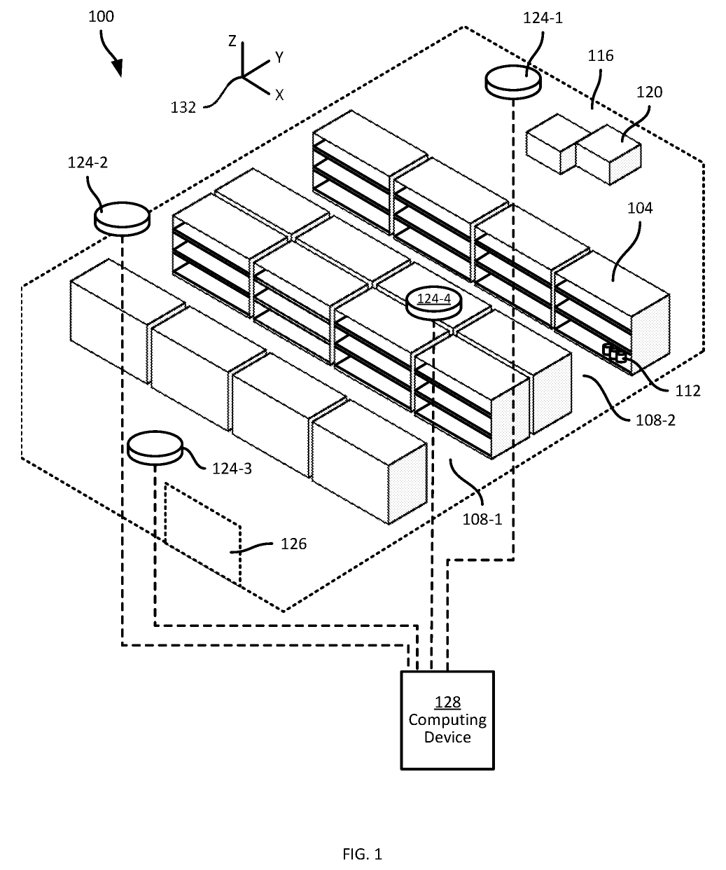

FIG. 1 illustrates an inventory tracking system 100, implemented in an example facility such as a retail store (e.g., a grocer, an apparel store, or the like). The system 100 can also be implemented in a wide variety of other facilities, including manufacturing facilities, healthcare facilities, warehouses or other transport and logistics-associated facilities, and the like. The facility contains a plurality of items, whose nature can depend on the nature of the facility. The facility can include, for example, a plurality of support structures 104 such as shelf modules, e.g., arranged into aisles 108-1 and 108-2. The support structures 104 can have various other forms, including tables, pegboards, and the like. The support structures 104 support items 112 thereon, e.g., for retrieval by customers, facility staff, and the like. In some examples, portions of the facility, such as a receiving and/or storage area 116, can store items 112 in boxes 120, boxes, or other aggregated forms, prior to removal of individual items 112 from storage for placement on the support structures 104.

The facility may contain a large number of distinct types of items (e.g., distinct stock-keeping units (SKUs)), and may also contain numerous items of each given type. Some facilities may contain tens or hundreds of thousands of individual items, of thousands of different types. Various processes involved in management of the facility may depend on accurate, substantially real-time information representing the number of items (e.g., of each item type) present in the facility. For example, procurement processes by which items are ordered for delivery to the facility may depend on maintaining certain stock levels. In other examples, determining and correcting inventory shrink (e.g., due to product damage, theft, administrative errors, or the like) can involve comparing an accurate representation of the items 112 present in the facility with one or more of incoming deliveries, sales data, or the like.

The significant number of items 112 in the facility, the variety of item types, and the fluid nature of the population of items 112 present in the facility at any given time (e.g., due to customer purchases, restocking, deliveries, and the like), can complicate accurate tracking of item inventory in the facility.

In some examples, the items 112 can carry RF tags, e.g., embedded in labels or other packaging affixed to the items 112. Each RF tag can store a unique identifier (e.g., unique at least within the facility), and in some cases can also store other information, e.g., a SKU code or the like. The system 100 includes at least one radiofrequency (RF) identification (RFID) reader, illustrated in FIG. 1 as four RFID readers 124-1, 124-2, 124-3, and 124-4. The RFID readers are also collectively referred to as RFID readers 124, and generically as an RFID reader 124. Similar nomenclature, with a reference number and a hyphenated suffix, is also used to refer to multiple instances of other elements discussed herein.

The RFID readers 124 can be mounted in various locations in the facility. For example, the readers 124-2 and 124-4 can be ceiling-mounted over the portion of the facility containing the support structures 104. The reader 124-3 can be mounted at an entrance and/or exit 126 to the facility, and the reader 124-1 can be mounted in or near the storage area 116 (e.g., on a ceiling). As will be apparent to those skilled in the art, the system 100 can include fewer than four, or more than four, RFID readers 124, and the readers 124 can be of different types, e.g., depending on their placement within the facility. RFID readers 124 can also be deployed at additional locations within the facility, such as at point-of-sale terminals, and the like.

The RFID readers 124 can be centrally controlled, for example by a computing device 128 such as a server executing control software, to periodically generate interrogation signals that are reflected by any RF tags within the facility (e.g., tags affixed to the items 112). A reading operation, in which interrogation signals are generated by the readers 124 and any reflected tag identifiers are provided to the computing device 128, can be repeated at various frequencies, e.g., every ten seconds, every minute, once per hour, or the like.

For each reading operation, the RFID readers can therefore detect a set of tag identifiers and provide the detected tag identifiers to the computing device 128. Detection of a tag identifier by one or more of the readers 124 in a given reading operation can be used to update inventory tracking data at the computing device 128. For example, the computing device 128 can maintain a repository of each item 112 received at the facility, the tag identifier associated with that item 112, and a presence indicator associated with the item 112, indicating whether the item 112 is present or absent in the facility. The computing device 128 can also maintain a last detected location of a given tag. Locations can be determined in a coordinate system 132 defined for the facility, for example by triangulation based on signal strengths for the same tag as read by a plurality of the readers 124. In other examples, the location stored for a given item 112 can be an identifier of the reader 124 that most recently read the tag corresponding to that item 112, e.g., providing an approximate location of the item 112, instead of or in addition to coordinates in the coordinate system 132

Use of the RFID readers 124 to periodically detect RF tags on the items 112 can facilitate the maintenance of substantially real-time inventory tracking data. However, in each reading operation performed by the RFID readers 124, a portion of the RF tags that are present in the facility may not be detected by any of the RFID readers 124. For example, a tag affixed to an item 112 near the center of the box 120 may be surrounded by other items 112, and may therefore be detected infrequently or not at all by the reader 124-1. In other examples, an RF tag affixed to a metallic item may be less likely to be successfully detected by a reader 124 as a result of interference from the item 112. In further examples, items 112 placed in a cart or bag by a customer may be difficult to detect by the readers 124, e.g., as a result of obstruction by other items 112 or nearby structural elements of the facility. For example, each reading operation may detect about 75% of the RF tags present in the facility. The remaining 25% may incorrectly appear, from the reading operation, to be absent from the facility. It will be understood that the example proportions given above can vary widely from facility to facility, and between reading operations in a given facility.

Missed tag reads can lead to inaccurate inventory tracking data. For example, if an RF tag previously marked as being present in the facility is not detected in a reading operation and thus marked absent from the facility, downstream actions such as ordering additional stock may be triggered incorrectly. Further, a missed tag read at the exit 126 may, for example, lead to the presence indicator of an item 112 indicating that the item 112 is present when that item 112 has actually left the facility. The appearance of inventory being present when that inventory is actually absent can lead to the cancellation of customer orders, depletion of stock in the facility due to delayed restocking orders, and the like.

In other words, setting the presence indicator for an item 112 based solely on whether or not the RF tag associated with that item is detected in a given reading operation is likely to lead to inaccurate presence indicators.

Some approaches to tracking inventory based on incomplete RFID reads involve applying rule sets and/or decision trees, e.g., incorporating contextual data associated with the relevant item 112. A simple example of such a rule set includes determining whether the location that a given RF tag was last read at corresponds to the exit 126, and determining whether the last read was more than a threshold period of time ago (e.g., one hour). When both of those conditions are met, the RF tag may be marked absent from the facility. In some examples, an additional condition can be applied, for example to modify the threshold time period when stored characteristics of the item 112 indicate that missed tag reads are more likely for that item 112. In another example, another condition can be applied, for example to further modify the threshold time period based on historical sales data for the item type corresponding to the RF tag. For example, item types with higher sales volumes may lead to reduced threshold time periods beyond which an unread RF tag is marked absent.

As will be apparent to those skilled in the art, the above rules and decision trees constructed from such rules can become highly complex, such that a decision of whether to mark a single RF tag as present or absent can involve dozens of separate sub-decisions, each taking a further branch in a decision tree. The rules used in the above approach may also vary by item type, by time of year (e.g., reflecting seasonal stock changes), and the like. Still further, rules applied at one facility are unlikely to be applicable at a different facility. The rules may therefore require frequent updating.

The complexity and volume of the rules and decision trees mentioned above can impose a significant computational burden on the computing device 128, given the number of individual RF tags to track. Further, the creation and updating of the above rules relies on subjective human judgement. For example, an administrator of the facility shown in FIG. 1 may be required to frequently alter the above rules in an attempt to improve the accuracy of inventory tracking data at the computing device 128. Such rule updates are made based on the experience and judgement of the administrator, which may be imperfect, and may not be applicable to other facilities. Each deployment of an inventory tracking system may therefore involve the time-consuming and error-prone creation and maintenance of a large and complex rule set.

As described below, the computing device 128 implements certain functionality that enables the computing device 128 to autonomously perform functions that, as outlined above, otherwise rely on human expertise and judgement. The computing device 128 is configured to combine RFID read results with various contextual data, and to execute a reinforcement learning module to determine the presence indicators for RF tags in the facility. The computing device 128 is further configured to update the reinforcement learning module based on automated evaluations of the selected presence indicators. The processes implemented by the computing device 128 can therefore improve the accuracy of inventory tracking data relative to the decision trees noted above, reduce the computational demand associated with selected presence indicators, and/or mitigate the need for manual creation and maintenance of such decision trees.

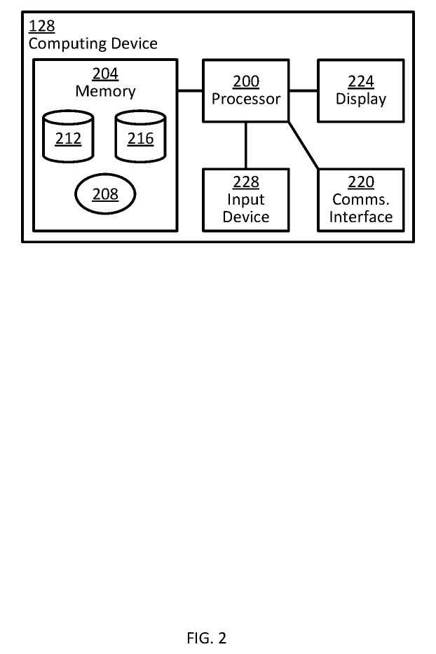

Turning to FIG. 2, before discussing the functionality of the computing device 128, certain internal components of the computing device 128 are shown. The device 128 includes a processor 200, such as a central processing unit (CPU), graphics processing unit (GPU), application-specific integrated circuit (ASIC), or the like. The processor 200 is communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications, including in the illustrated example an inventory tracking application 208, whose execution by the processor 200 configures the device 128 to process read results data captured via the RFID readers 124 and determine presence indicators for a plurality of RF tags.

The memory 204 can also store a repository 212 of tag identifiers and presence indicators. The repository 212 can, in other words, contain inventory tracking data for the facility. Various other attributes of the items 112 can also be stored in the repository 212, such as item categories, e.g., to categorize the items 112 into types of merchandise (e.g., produce, meat, baking items, and the like), and/or to categorize the items 112 by RF reading difficulty (e.g., with metallic items 112 categorized as difficult to read). The repository 212 can further contain historical RF read data, for example including at least one previous read time and location for the corresponding RF tag.

The memory 204 can also store, e.g., in another repository 216, various operational data associated with the facility. Operational data can include sales data, e.g., indicating item types sold (e.g., SKU codes) and timestamps indicating when the sales occurred. The operational data can also include picking data, e.g., for online order fulfillment. For example, a pick operation can include capturing the tag identifier for a picked item, for storage in the repository 216 in association with an order. Various other operational data will also occur to those skilled in the art, including delivery data, shipping data, and the like.

The device 128 also includes a communications interface 220, enabling the device 128 to communicate with other computing devices, including the RFID readers 124, via any suitable communications links, including wireless and/or wired local-area and/or wide-area networks. In some examples, either or both of the repositories 212 and 216 can be stored remotely from the device 128, e.g., by a logically distinct computing device, and accessed by the device 128, via the communications interface 220. The device 128 can also include one or more output devices, such as a display 224, and one or more input devices 228, such as a keyboard, mouse, touch screen, or the like.

The device 128 can be implemented as a desktop computer, a standalone server or the like, in some examples. In other examples, the device 128 can be implemented in a distributed manner, e.g., with one or more networked physical computing devices being logically associated to implement the functionality described below in connection with the device 128.

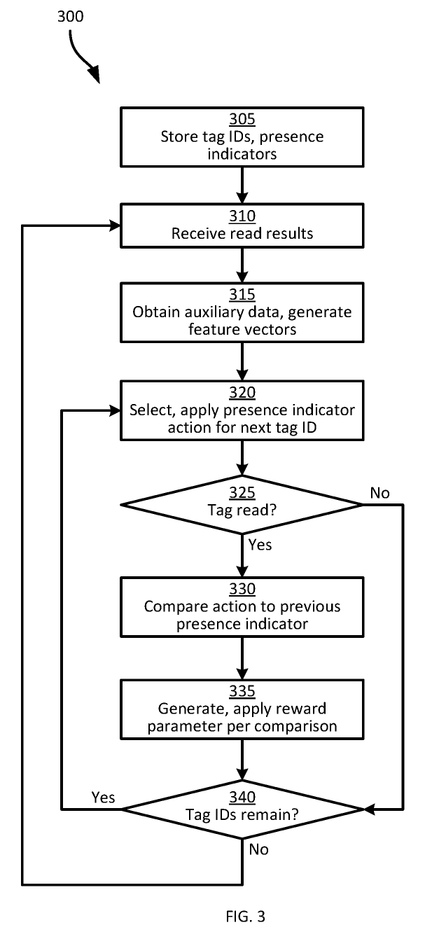

Turning to FIG. 3, a method 300 of adaptive inventory tracking is illustrated. The method 300 is described below in conjunction with its performance in the system 100, e.g., via execution of the application 208 by the processor 200, and/or by equivalent dedicated hardware elements such as an ASIC, field-programmable gate array (FPGA) or the like implementing the functionality of the application 208.

At block 305, the device 128 is configured to store a plurality of RF tag identifiers, and for each identifier, an indicator of whether the corresponding RF tag is present or absent in the facility. The tag identifiers and presence indicators can be stored in the repository 212, e.g., in the memory 204, although as noted earlier, the repository 212 can also be hosted remotely from the device 128 in some examples. The provisioning of the repository 212 with tag identifiers can be performed according to various processes. For example, new tag identifiers can be added to the repository 212 when shipments of items 112 are received at the facility. For example, a delivery manifest or the like can include tag identifiers and other information, which can be input to the repository 212.

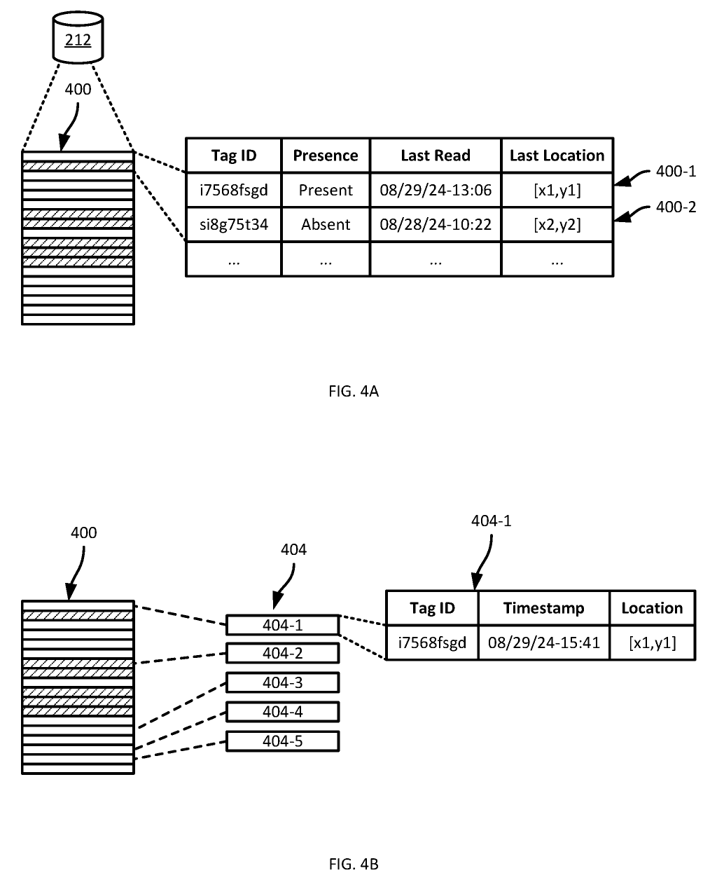

FIG. 4A illustrates example contents of the repository 212, including a plurality of records 400, each corresponding to one RF tag. In the illustrated example, the repository 212 includes eighteen records 400. It will be understood that the repository 212 can contain tens or hundreds of thousands of records 400 in other examples, however. Certain records 400 are illustrated with a solid fill in FIG. 4A, while other records 400 are illustrated with a hatched fill. A record 400 with a solid fill contains a presence indicator marking the corresponding RF tag as present in the facility, and a record 400 with a hatched fill contains a presence indicator marking the corresponding RF tag as absent in the facility. Two example records 400-1 and 400-2 are illustrated in greater detail. As seen in FIG. 4A, the record 400-1 corresponds to a tag with the identifier “i7568fsgd”, which is currently marked as being present in the facility. The record 400-2 corresponds to a tag with the identifier “si8g75t34”, which is currently marked as being absent from the facility.

Each record 400 can also include certain contextual information corresponding to the relevant RF tag. For example, the records 400-1 and 400-2 each contain a timestamp (e.g., a date and a time of day) of the most recent capture of the tag identifier by the RFID readers 124, and a location (e.g., in the coordinate system 132) of the tag at that time. Various other contextual data can also be stored in the records 400, such as one or more categories associated with the RF tag (e.g., indicating attributes of an item to which a RF tag is affixed).

Returning to FIG. 3, at block 310 the device 128 is configured to receive read results from the RFID readers 124. For example, the device 128 can command the RFID readers 124 to perform a tag reading operation, or the RFID readers 124 can be configured to automatically perform a read at a predetermined frequency and provide the results of the read to the device 128. The read results received at block 310 include at least tag identifiers, and can also include timestamps and locations corresponding to the tag identifiers, e.g., expressed as coordinates in the coordinate system 132.

FIG. 4B illustrates example read results 404 received at block 310. The read results 404 include a plurality of read records 404-1, 404-2, 404-3, 404-4, and 404-5. Each record 404, as illustrated for the record 404-1, contains a tag identifier, as well as a timestamp and a location. Each record 404 can also include other information in some examples, such as a received signal strength indicator (RSSI) for each RFID reader 124 that detected that tag. In some examples, the RF tags can store additional item information, such as SKU codes, Universal Product Identifiers (UPCs) or the like. Such additional information can also be contained in the records 404, when present.

As shown in FIG. 4B, the read results 404 contain a subset of the tag identifiers in the repository 212. In other words, certain tag identifiers that are marked as present in the facility are not represented in the read results 404. In the example illustrated in FIG. 4B, of the thirteen tags marked as present, five are represented in the read results 404. Among the other eight tags identified in the repository 212, some may be present but missed by the most recent read, while others may no longer be present in the facility. In some examples, a tag previously marked as absent may be detected at block 310 (e.g., in the case of the tag corresponding to the read record 404-2).

Returning to FIG. 3, at block 315, the device 128 is configured to generate a feature set, e.g., in the form of a numerical vector, for each of the tag identifiers from block 305. The feature sets generated at block 315 are used as inputs for a reinforcement learning module, to determine whether to update each of the presence indicators in the repository 212. That is, the device 128 is configured to generate a feature set not only for the subset of tag identifiers contained in the read results at block 310, but also for the tag identifiers for which no read result was obtained at block 310.

The computing device 128 can be configured to generated a feature vector for a tag identifier by combining the read results (e.g., the read record 404 for a given tag identifier) with contextual data corresponding to the tag identifier. The computing device 128 can store or access configuration data (e.g., as a component of the application 208, or as a separate file in the memory 204) that defines the structure and content of the feature vector.

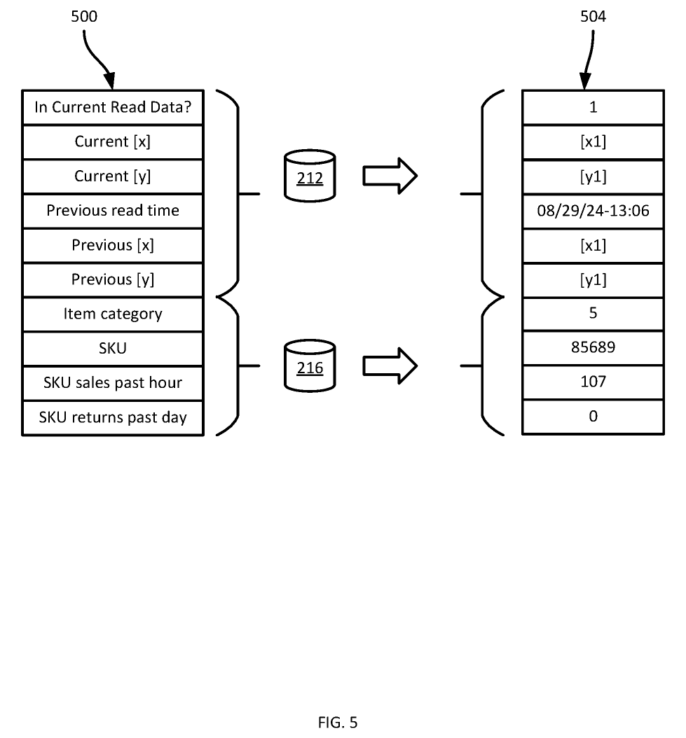

The feature vector includes a plurality of parameters corresponding to the RF tag, operations of the facility that may be indicative of whether the RF tag is present or absent, and/or events in the facility that may be indicative of whether the RF tag is present or absent. Turning to FIG. 5, example configuration data 500 used by the device 128 to generate the feature vector is illustrated. The configuration data includes, in this example, a sequence of definitions (presented in plain language in FIG. 5 for illustrative purposes) for generating respective numerical values from data retrieved from either or both of the repositories 212 and 216.

The device 128 is configured, for each definition in the configuration data 500, to retrieve the corresponding source data from one or both of the repositories 212 and 216, and to process the retrieved source data to generate a numerical value. The numerical value is a component of a feature vector 504, e.g., positioned in the feature vector 504 based on the position of the corresponding definition in the configuration data 500. To generate the feature vector 504, the device 128 processes the relevant source data for each of the definitions in the configuration data 500.

The configuration data 500 includes, in this example, a first definition “In Current Read Data?”. The device 128 determines whether the corresponding tag identifier (e.g., “i7568fsgd” in this example) appears in the read results 404 from block 310. The value generated for the vector 504 can be a binary value, such as a one when the determination above is affirmative because the RF tag was detected in the most recent reading operation, or a zero when the determination above is negative because the RF tag was not detected in the most recent reading operation. In this example, the above tag was detected at block 310 (as shown in the read record 404-1), and the value “1” is inserted into the feature vector 504. The next two definitions in the configuration data 500 correspond to the positions of the RF tag, as detected at block 310, on the “x” and “y” axes of the coordinate system 132. The device 128 is configured to insert the values [x1] and [y1] from the record 404-1 into the feature vector 504. In other examples, in addition to or instead of coordinates, the configuration data can specify zones of the facility, such as a zone adjacent to the exit 126, a zone containing the shelf modules 104, and a zone containing the storage area 116. The device 128 can determine which zone the location [x1, y1] falls within, and insert an index value corresponding to that zone in the feature vector 504. When the RF tag was not read at block 310, the current location values can be set to zero.

The configuration data 500 further defines a previous read timestamp, and previous read location, for the RF tag. The previous read time and location can be retrieved, in this case, from the record 400-1 and inserted into the feature vector 504. In other examples, depending on the nature of historical read results stored in the repository 212, the configuration data 500 can define one or more aggregated values, such as a number of times over a given interval (e.g., the past hour, the past day, or the like) that the RF tag was successfully read at block 310.

The configuration data 500 also defines an item category value, e.g., obtained by looking up the RF tag identifier in the repository 216 to retrieve a corresponding merchandise category, and/or a corresponding item attribute category associated with the RF tag. For example, the repository 216 can contain a mapping of each tag identifier to a SKU, UPC or the like, and a mapping of SKU codes or UPCs to item categories. The repository 216 can also contain, in some examples, a mapping of SKUs or UPCs to item attributes, for example dividing the items 112 into items that are likely to render RF reading difficult due to metallic components or the like, and items that are not likely to impede reading of their RF tags. The configuration data 500 can define index values or other numerical representations of the above categories, which can be inserted into the feature vector 504 (e.g., the category of the item 112 associated with the tag identifier i7568fsgd has the index value “5”).

The configuration data 500 further indicates that the SKU code associated with the tag identifier is to be inserted in the feature vector 504. The configuration data 500 also defines two features derived from sales data from the repository 216 in this example. To generate a value for “SKU sales past hour” the device 128 can query the repository 216 for transactions including the SKU code mentioned above and having occurred in the past hour (although any of a wide variety of time periods can be used). To generate a value for “SKU returns past day” the device 128 can query the repository 216 for any return transactions having the SKU code mentioned above (indicating the return of one or more previously departed items to the facility).

The configuration data 500 can define a wide variety of other values for the feature vector 504, including the current presence indicator for the corresponding tag, sales data for items 112 related to the item 112 bearing the RF tag, read data for such related items (e.g., times and/or locations at which one or more related items were most recently read, a number of such related items within a threshold distance of the RF tag in the read data, or the like), an expected location for the item based on a planogram of the facility, and the like. The values in the feature vector 504 may be indicative of whether the corresponding RF tag is present or absent in the facility. The specific relationship between the values of a given feature vector 504 and the presence of absence of the corresponding RF tag may not be known, however, and may also vary over time (e.g., seasonally or the like).

Referring again to FIG. 3, once feature vectors 504 have been generated for each tag identifier in the repository 212 (e.g., including both those appearing in the read results 404 from block 310, and those not appearing in the read results 404), at block 320 the computing device 128 is configured to execute a reinforcement learning module, using the feature vectors 504 as input to the reinforcement learning module. Execution of the reinforcement learning module permits the device 128 to select an action predictive of whether the corresponding RF tag for each feature vector 504 is present in the facility. The actions selected via execution of the reinforcement learning module can include, for example, updates to the repository 212 such as setting a tag’s presence indicator to present, setting a tag’s presence indicator to absent, or leaving the tag’s presence indicator unchanged from its previous state.

A variety of reinforcement learning algorithms can be implemented by the application 208 or an associated application at the device 128. For example, the application 208 can implement a model-free reinforcement learning algorithm, such as a Deep Q Network (DQN), a Policy Gradient algorithm, an Actor Critic algorithm, or the like. Other examples may also occur to those skilled in the art.

A reinforcement learning process implements an agent that takes actions (e.g., in this case, a component of the application 208 that updates presence indicators in the repository 212). The actions can be taken based on an observed state of an environment, e.g., the read results from block 310, the previous content of the repository 212, and any auxiliary data used to generate the feature vectors 504. The agent subsequently receives a new observed state of the environment, along with one or more feedback parameters referred to as a reward, which indicates a favorability (or lack of favorability, as a given reward can be either positive or negative) of the previously-selected action, e.g., based on a comparison between the previous environmental state and the newly observed environmental state. The reward is used to update the mechanism(s) by which the next action is selected. The updates made to the action selection mechanism(s) seek to maximize the total rewards received over time. The reinforcement learning algorithm performs the above process iteratively, to determine an optimal action for each environmental state.

In the present example, the application 208 implements a DQN, in which a deep neural network (having at least one “hidden” layer of nodes) determines, for a given feature vector 504, values for each of the possible actions (e.g., update to “present”, update to “absent”, or retain previous presence indicator) for the corresponding RF tag. The complexity of the environmental state in the system 100 is such that an explicit mapping of individual states (of which there may be billions or more) to actions, e.g., in a lookup table as in some reinforcement learning algorithms, may be computationally intractable. The neural network of a DQN, or other suitable mechanisms for approximating a function relating environmental states to action values, permits the device 128 to determine actions even in complex environments.

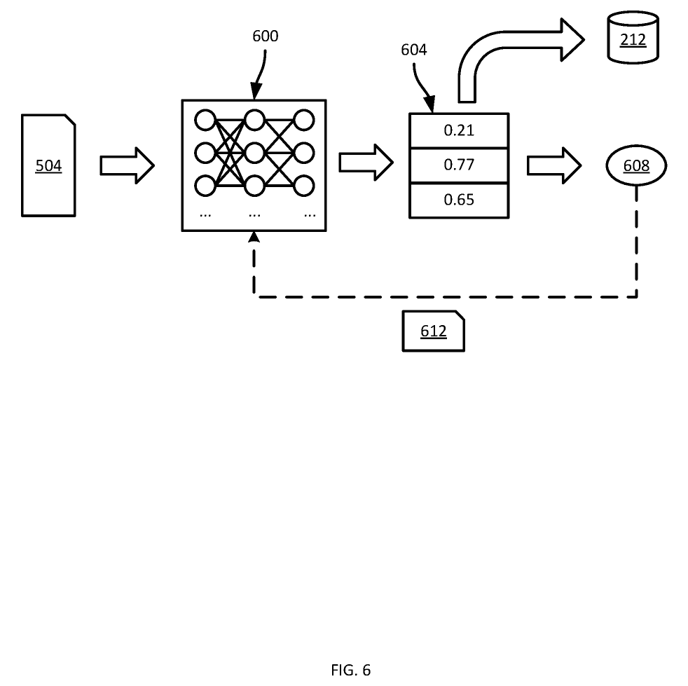

Referring to FIG. 6, an example performance of block 320 is illustrated. In this example, a feature vector 504 for a given RF tag is provided as input to a neural network 600 (or other suitable value-function approximator). The network 600 generates a set of values 604, each corresponding to one of a predetermined set of actions. In this example, the values 0.21, 0.77, and 0.65 are generated for, respectively, updating the presence indicator of the RF tag to “present”, retaining the existing presence indicator, and updating the presence indicator to “absent”. In other examples, the neutral, or retaining, action can be omitted. The values generated by the network 600 are indicative of the expected return associated with taking the corresponding actions. A higher value may, for example, indicate that the corresponding action is more likely to be the optimal action for the current environmental state.

The device 128 is configured to select an action based on the values 604, e.g., by selecting the highest value. The device 128 is configured to apply the corresponding action to the repository 212, e.g., updating the record 400 corresponding to the RF tag for which the feature vector 504 was generated. In this example, the highest of the values 604 corresponds to the “neutral” action, which retains the previous presence indicator. In other words, the RF tag corresponding to the record 400-1 continues to be marked as present in the facility.

The device 128 also determines and applies a reward to the network 600, based on a comparison of the previous presence indicator, and the presence indicator resulting from application of the action selected at block 320. The application 208 can include, for example, a reward generator module 608, configured to generate a reward 612 used to update one or more node weights in the network 600. As will be understood by those skilled in the art, the determination and application of the reward in a DQN can include the generation of a target value from a secondary network (which may be referred to as a target network), combination of a reward value 612 with the target value, and determination of a loss function based on the value from the network 600 and the target value. The loss can be back-propagated to the network 600 to update one or more node weights.

The reward 612 can be determined, returning to FIG. 3, via a comparison between the previous presence indicator and the newly selected presence indicator, at blocks 325, 330, and 335. At block 325, the device 128 is configured to determine whether the RF tag for which an action was selected at block 330 appeared in the read results from block 310 (e.g., whether the RF tag was successfully read in the most recent reading operation). When the determination at block 325 is negative, the determination of a reward is bypassed, and the device 128 proceeds to block 340. If the relevant RF tag was not read, the reward is neutral (e.g., neither positive nor negative), and no updates are made to the network 600.

When the determination at block 325 is affirmative, at block 330 the device 128 is configured to compare the current presence indicator corresponding to the action selected at block 320 with the previous presence indicator stored in the repository 212 prior to the update from block 320. At block 335, the device 128 is configured to generate a positive or negative reward based at least in part on the comparison.

The device 128 can be configured, for example, to generate a positive reward when the previous presence indicator from the relevant record 400-1 was “present” (or a value with an equivalent meaning), and the selected action is neutral (e.g., apply no chance to the repository 212) or when the selected action is to set the presence indicator to “present”. Such a comparison indicates that the previous action selected based on the output of the network 600 is aligned with the current detection of the RF tag. The previous action was therefore likely to be accurate.

The device 128 can also be configured to generate a negative reward when the previous presence indicator from the relevant record 400-1 was “absent” (or a value with an equivalent meaning), and the selected action is to mark the corresponding RF tag as present. The presence of the corresponding RF tag indicates that the previous action to mark the tag as absent was likely incorrect. The device 128 can also be configured, in some examples, to retrieve return records, e.g., from the repository 216, and determine whether the tag identifier under consideration at blocks 330 and 335 has been returned to the facility. The negative reward may be generated, for example, when there are no returns associated with the tag identifier.

The initial value of the reward generated at block 335 can be scaled in some implementations. For example, if the age of a previous read of a RF tag is greater than a threshold (e.g., the time elapsed since the previous read exceeds one week, although a variety of other time periods, either shorter or longer, can be used), and the previous presence indicator is “present”, the reward can be scaled up (e.g., by a predefined multiplier, or by a factor proportional to the age of the previous read) when the network 600 selects an action to mark the tag as present. Scaling the reward under such conditions can compensate for infrequent reads of tags that may be on items 112 that interfere with RFID reading, or that are in portions of the facility with weaker coverage by the readers 124.

At block 340, the device 128 is configured to determine whether any tag identifiers remain to be processed. When the determination at block 340 is affirmative, the device 128 is configured to return to block 320. When determination at block 340 is negative, the device 128 can end the performance of the method 300, or return to block 310 for the next performance of the method 300, e.g., following a predetermined time interval.

The device 128 can also generate, e.g., in response to updates to the repository 212 at block 320, one or more events, control actions, notifications, or the like. For example, the device 128 can generate low-stock notifications in response to determining that the remaining stock level for a type of item has fallen below a threshold. In other examples, the device 128 can generate plug notifications, e.g., if a RF tag is determined to be present in the facility, but in an unexpected location (e.g., deviating from that item type’s expected location according to a planogram).

As will be understood from the discussion above, performance of the method 300 by the computing device provides a technical improvement to the functioning of the device 128. The generation of feature vectors 504, selection of update actions using a reinforcement learning module, and the updating the reinforcement learning module via comparisons between the selected updates and previously stored tag presence indicators permit the device 128 to track inventory substantially autonomously. The creation and maintenance of rules and/or decision trees via subjective human judgement can be avoided through the performance of the method 300, and the inventory tracking implemented by the device 128 can therefore be readily scaled to a plurality of facilities. Further, the accuracy of the inventory tracking implemented by the device 128 may be improved. As a result of improved inventory tracking accuracy, downstream actions such as notifications, stock orders, and the like, are also more likely to be relevant to the facility.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
storing a plurality of identifiers of radiofrequency (RF) tags, and for each identifier, an indicator of whether the corresponding RF tag is present in a facility;
receiving read data containing a subset of the identifiers detected by a RF identification (RFID) reader;
for each of the plurality of identifiers:
(i) generating a feature vector by combining the read data with contextual data corresponding to the identifier; and
(ii) executing a reinforcement learning module using the feature vector to select an action predictive of whether the corresponding RF tag is present in the facility;
updating the stored indicators according to the selected actions; and
for each identifier in the subset detected by the RFID reader, applying a reward to the reinforcement learning module based on a comparison of the indicator and the updated indicator corresponding to the identifier.

2. The method of claim 1, wherein the action is selected from the group consisting of:
retaining a current value of the indicator;
setting the indicator to indicate that the RF tag is present in the facility; and
setting the indicator to indicate that the RF tag is absent from the facility.

3. The method of claim 1, wherein applying the reward includes:
when the selected action predicts that the RF tag is present in the facility, and the stored indicator indicates that the RF tag is present in the facility, applying a positive reward.

4. The method of claim 3, wherein applying the positive reward includes:
determining an initial reward value; and
scaling the initial reward value according to a period of time elapsed since the receipt of previous read data containing the identifier.

5. The method of claim 1, wherein applying the reward includes:
when the selected action predicts that the RF tag is present in the facility, and the stored indicator indicates that the RF tag is absent from the facility, applying a negative reward.

6. The method of claim 5, further comprising:
prior to applying the negative reward, determining that an item associated with the RF tag has not been returned to the facility.

7. The method of claim 1, wherein the contextual data includes at least one of:
the stored indicator corresponding to the identifier,
a location from the read data associated with the identifier,
previous read data containing the identifier,
a category of item associated with the RF tag,
sales data corresponding to a type of item associated with the RF tag,
delivery data corresponding to a type of item associated with the RF tag,
shipping data corresponding to a type of item associated with the RF tag, or
picking data corresponding to a type of item associated with the RF tag.

8. The method of claim 7, wherein generating the feature vector includes:
determining whether the identifier is contained in the read data.

9. The method of claim 7, wherein generating the feature vector includes at least one of:
determining a number of times the identifier has appeared in previous read data;
determining a period of time elapsed since the identifier was contained in the previous read data;
determining a location associated with the identifier in the previous read data; or
identifying, in the previous read data, locations of at least one item related to an item associated with the RF tag.

10. A computing device, comprising:
a memory storing a plurality of identifiers of radiofrequency (RF) tags, and for each identifier, an indicator of whether the corresponding RF tag is present in a facility; and
a processor configured to:
receive read data containing a subset of the identifiers detected by a RF identification (RFID) reader;
for each of the plurality of identifiers:
(i) generate a feature vector by combining the read data with contextual data corresponding to the identifier; and
(ii) execute a reinforcement learning module using the feature vector to select an action predictive of whether the corresponding RF tag is present in the facility;
update the stored indicators according to the selected actions; and
for each identifier in the subset detected by the RFID reader, apply a reward to the reinforcement learning module based on a comparison of the indicator and the updated indicator corresponding to the identifier.

11. The computing device of claim 10, wherein the action is selected from the group consisting of:
retaining a current value of the indicator;
setting the indicator to indicate that the RF tag is present; and
setting the indicator to indicate that the RF tag is absent.

12. The computing device of claim 10, wherein the processor is configured to apply the reward by:
when the selected action predicts that the RF tag is present in the facility, and the stored indicator indicates that the RF tag is present, applying a positive reward.

13. The computing device of claim 12, wherein the processor is configured to apply the positive reward by:
determining an initial reward value; and
scaling the initial reward value according to a period of time elapsed since the receipt of previous read data containing the identifier.

14. The computing device of claim 10, wherein the processor is configured to apply the reward by:
when the selected action predicts that the RF tag is present in the facility, and the stored indicator indicates that the RF tag is absent, applying a negative reward.

15. The computing device of claim 14, wherein the processor is further configured to:
prior to applying the negative reward, determine that an item associated with the RF tag has not been returned to the facility.

16. The computing device of claim 10, wherein the contextual data includes at least one of:
the stored indicator corresponding to the identifier,
a location from the read data associated with the identifier,
previous read data containing the identifier,
a category of item associated with the RF tag,
sales data corresponding to a type of item associated with the RF tag,
delivery data corresponding to a type of item associated with the RF tag,
shipping data corresponding to a type of item associated with the RF tag, or
picking data corresponding to a type of item associated with the RF tag.

17. The computing device of claim 16, wherein the processor is configured to generate the feature vector by:
determining whether the identifier is contained in the read data.

18. The computing device of claim 16, wherein the processor is configured to generate the feature vector by at least one of:
determining a number of times the identifier has appeared in previous read data;
determining a period of time elapsed since the identifier was contained in the previous read data;
determining a location associated with the identifier in the previous read data; or
identifying, in the previous read data, locations of at least one item related to an item associated with the RF tag.
